(19) United States
(12) Patent Application Publication
(10) Pub. No.: US 2022/0048585 A1
(43) Pub. Date: Feb. 17, 2022

(54) SADDLE FOR BICYCLES

(71) Applicant: SELLE ITALIA S.R.L., Asolo (Trevison) (IT)

(72) Inventor: Riccardo BIGOLIN, Castelcucco (Treviso) (IT)

(21) Appl. No.: 17/297,774

(22) PCT Filed: Dec. 2, 2019
(86) PCT No.: PCT/IB2019/060354

§ 371 Date: May 27, 2021

(30) Foreign Application Priority Data
Dec. 3, 2018 (IT) 102018000010759

(51) Int. Cl. B62J 1/00; B62J 1/08; B62J 1/10

(52) U.S. Cl. CPC B62J 1/002; B62J 1/10; B62J 1/08

(57) ABSTRACT

A saddle for bicycles has a body and a frame for supporting the body. The body has at least one slot at least partly extending in the rear portion of the body defining a right rear portion and a left rear portion of the saddle. The frame has a first branch and a second branch configured to be removably connected, respectively, to the right rear portion and to the left rear portion of the body passing from a first connecting configuration to a second connecting configuration, and vice versa. A bridge element that connects the first branch and the second branch is configured for removably coupling to the body to define a first distance and a second distance between the right rear portion and the left rear portion of the body. The first distance and the second distance correspond, respectively, to the first connecting configuration and the second configuration.

### TECHNICAL FIELD

This invention relates to a saddle for bicycles.

The saddle for bicycles according to the invention is applied in particular in the technical field of bicycles.

### BACKGROUND ART

In particular, the saddle according to the invention is inserted in the technical field of the so-called adjustable saddles, that is to say, in which it is possible to adjust the width of the saddle at least from a minimum width to a maximum width, and vice versa, in particular from a size “S”, or “small”, to a size “L”, or “large”, and vice versa.

An example of an adjustable saddle is known from patent document WO2016094499.

### DISCLOSURE OF THE INVENTION

In order to facilitate the adjustment operation by the user, the Applicant has devised a new adjustable saddle solution.

In this context, one aspect of the invention is that of providing a saddle for bicycles which comprises a body and a frame for supporting the body. The body has at least one slot which extends at least partly in the rear portion defining a right rear portion and a left rear portion of the saddle.

The frame comprises at least a first branch and a second branch configured to be connected in a removable fashion, respectively, to the right rear portion and to the left rear portion of the body passing at least from a first connecting configuration to a second connecting configuration, and vice versa. A transversal member connects the first branch and the second branch of the frame and is configured to couple in a removable fashion to the body in such a way as to define a first and a second distance between the right rear portion and the left rear portion of the body.

The first distance and at the second distance between the right rear portion and the left rear portion of the body correspond, respectively, to the first connecting configuration and the second connecting configuration of the frame to the body.

Advantageously, the transversal member which can be coupled to the body allows the right rear portion and the left rear portion of the body to be kept in position in the desired size, until the frame is stably connected to the body, thus facilitating the size change-over operation by the user.

### BRIEF DESCRIPTION OF DRAWINGS

Further features and advantages of this invention are more apparent in the detailed description below, with reference to a preferred, non-limiting, embodiment of saddle for bicycles as illustrated in the accompanying drawings, in which:

FIG. 1 is a schematic perspective view of the saddle for bicycles according to the invention;

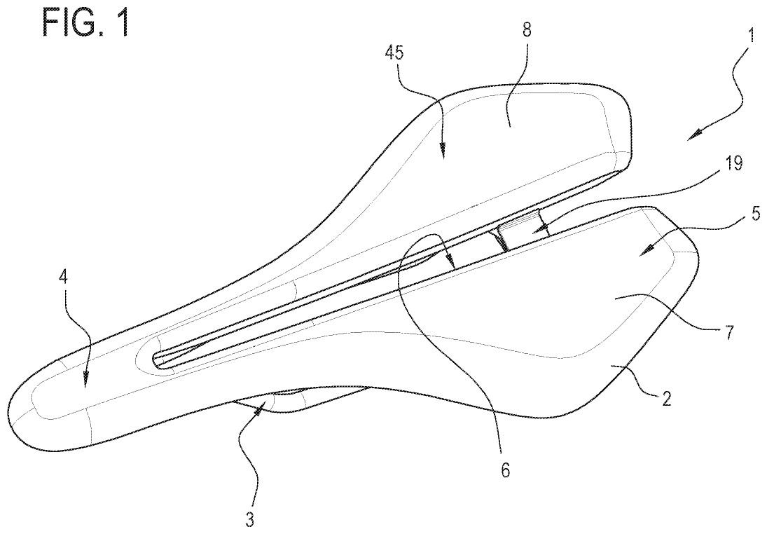

FIG. 2 is an exploded schematic perspective view of the saddle of FIG. 1;

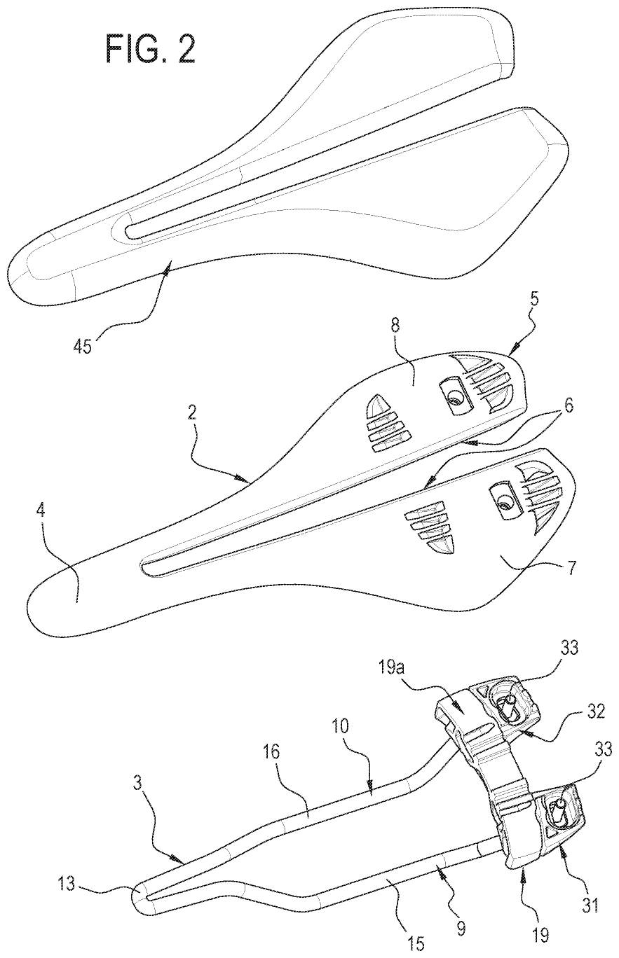

FIG. 3 is a further exploded schematic perspective view of the saddle of FIG. 1;

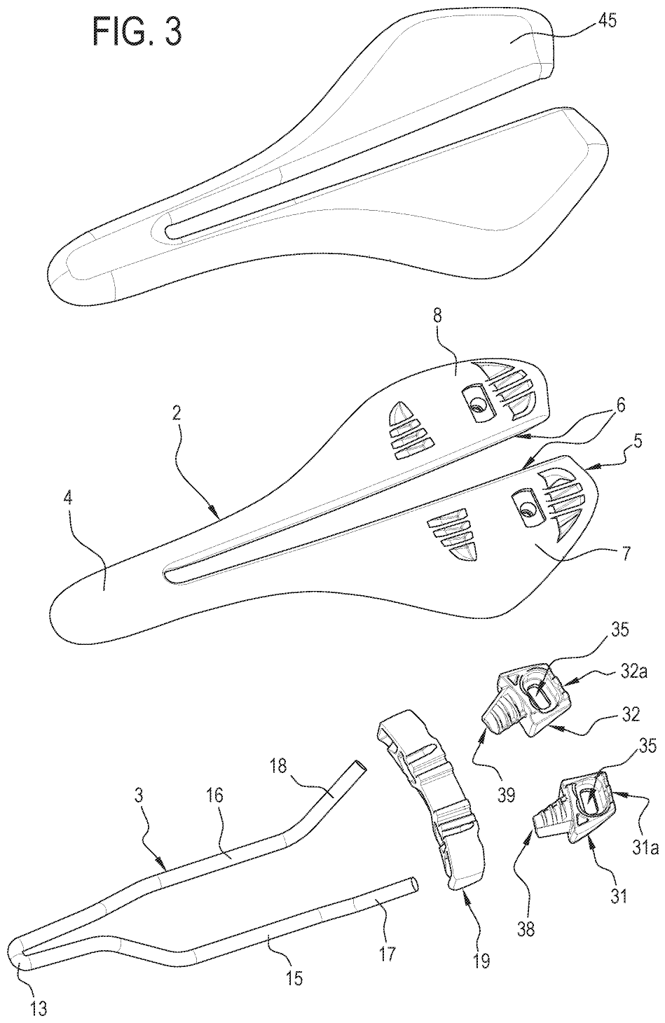

FIG. 4 is a schematic perspective view of a body of the saddle of FIG. 1 positioned overturned;

FIGS. 5 and 6 are schematic perspective views of a transversal member of the frame, shown in the exploded views of FIGS. 2 and 3;

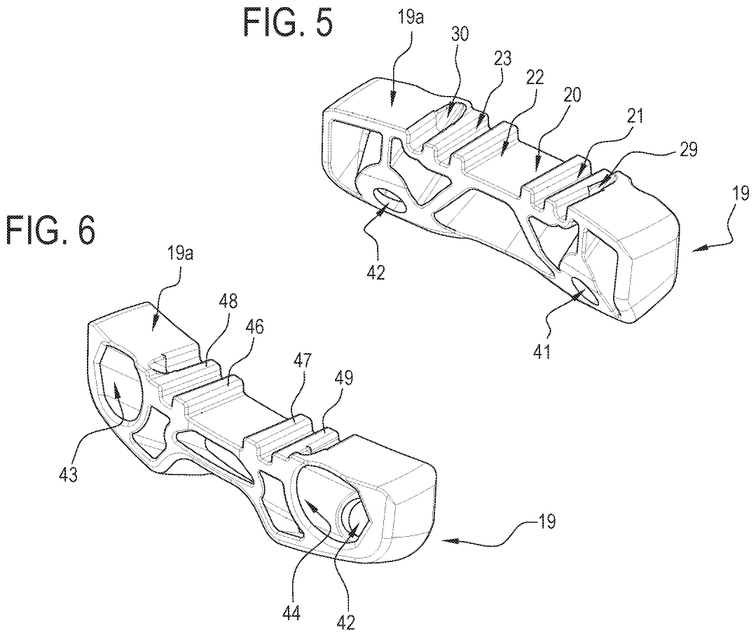

FIG. 7 and FIG. 8 are a schematic plan view of the saddle of FIG. 1 in a configuration of minimum width and in a configuration of maximum width.

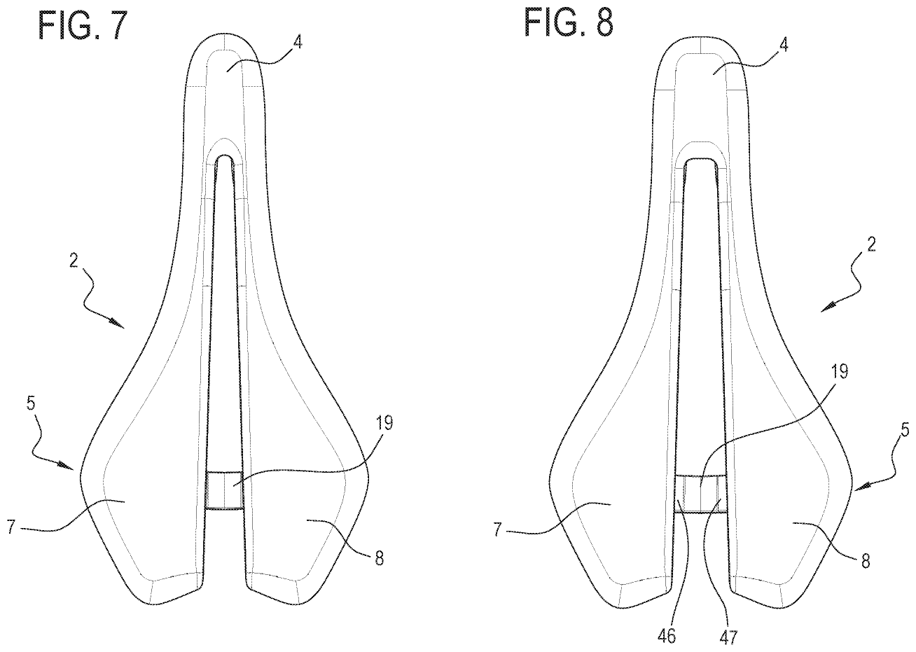

### DETAILED DESCRIPTION OF PREFERRED EMBODIMENTS OF THE INVENTION

With reference to the accompanying drawings, the numeral 1 denotes a saddle for bicycles according to the invention.

The saddle 1 comprises a body 2 and a frame 3 for supporting the body 2. The body 2 of the saddle 1 may be covered at least partly by a padding 45, covered optionally, in turn, by an upper cover, or the body 2 may not be covered.

The body 2 comprises a front portion 4 and a rear portion 5, which define the shape of the saddle 1.

The front portion 4 is the portion of the saddle 1 shaped in the form of a tip.

The rear portion 5 defines the seat of the cyclist on the saddle 1.

The rear portion 5 has a transversal dimension, greater than the front portion 2, with reference to the longitudinal extension of the saddle 1.

The width of the saddle 1 is determined by the transversal dimension of the rear portion 5, relative to the longitudinal extension of the saddle 1.

In order to define the front portion 4 and the rear portion 5 of the saddle 1, the body 2 may be made as a single piece, or, alternatively, comprise a plurality of parts connected to each other.

The body 2 of the saddle 1 has slot 6 which extends at least partly in the rear portion 5, forming a right rear portion 7 and a left rear portion 8 of the body 2.

The width of the slot 6 determines the distance between the right rear portion 7 and the left rear portion 8, thus defining the width of the saddle 1. The frame 3 of the saddle 1 comprises at least a first branch 9 and a second branch 10.

The first branch 9 and the second branch 10 of the frame 3 have respective stretches 15, 16 positioned parallel to each other, according to the longitudinal direction of extension of the saddle 1. The stretches 15, 16 of the first and second branch 9, 10 define means for anchoring the saddle 1 to the tubular element of the bicycle, not illustrated. A bridge element 19 connect the first branch 9 and the second branch 10 of the frame 3.

The bridge element 19 defines transversal member 19 for connecting between the first branch 9 and the second branch 10.

The first and second branches 9, 10 are connected to each other by a joint branch 13, in particular in the shape of a “U”, which extends continuously from the first branch 9 to the second branch 10.

The junction branch 13 is connected to the body 2 at the front portion 4 of the body 2 in a front connecting zone 11 of the body 2.

The first branch 9 is connected to the rear portion 5 of the body 2 at a rear connecting zone 12.

In particular, an end portion 17 of the first branch 9 is connected to the body 2 at the right rear portion 7 in the rear connecting zone 12.

The second branch 10 is connected to the body 2 at the rear portion 5 of the body 2 at a rear connecting zone 14.

In particular, an end portion 18 of the second branch 10 is connected to the body 2 at the left rear portion 8 in the rear connecting zone 14.

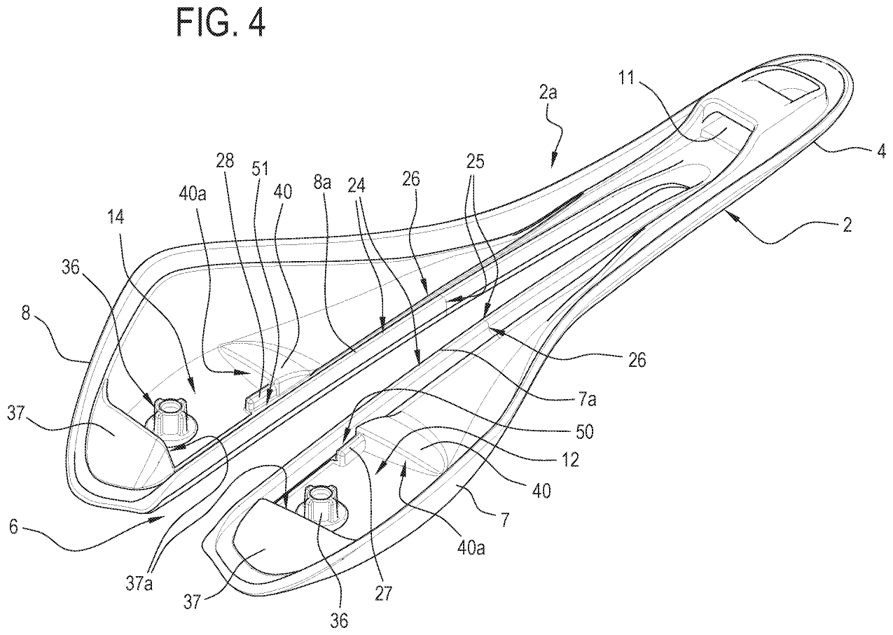

It should be noted that the connecting zones 11, 12, 14 of the frame 3 to the body 2, both front and rear, refer to the surface 2a of the body 2 facing towards the frame 3, accessible by overturning the saddle 1 relative to its position of normal use (see FIG. 4).

The frame 3 of the saddle 1 is configured to be connected in a removable fashion to the rear portion 5 of the body 2 to pass at least from a first connecting configuration to a second connecting configuration, and vice versa.

Each configuration for connecting the frame 3 to the body 2 determines the width of the saddle 1. The first configuration for connecting the frame 3 to the body 2 corresponds to a minimum distance between the right rear portion 7 and the left rear portion 8, defining the minimum width of the saddle 1.

In other words, in the first configuration for connecting the frame 3 to the body 2, the width of the slot 6 is at its minimum.

The second configuration for connecting the frame 3 to the body 2 corresponds to a maximum distance between the right rear portion 7 and the left rear portion 8, defining the maximum width of the saddle 1.

In other words, in the second configuration for connecting the frame 3 to the body 2, the width of the slot 6 is at its maximum.

The saddle 1 comprises a first element 31 for coupling an end portion 17 of the first branch 9 to the body 2 and a second element 32 for connecting an end portion 18 of the second branch 10 to the body 2.

The first connecting element 31 has a seat 38 for housing the end portion 17 of the first branch 9 and the second connecting element 32 has a seat 39 for housing the end portion 18 of the second branch 10.

Removable connecting means 33 removably connect the first connecting element 31 and the second connecting element 32 at a respective rear connecting zone 12, 14 of the body 2.

Preferably, the removable connecting means 33 are in the form of screws. The first connecting element 31 and the second connecting element 32 have a respective through slot 35 in which the removable connecting means 33 engage.

In particular, a respective connecting screw 33 is engaged in each slot 35. Each slot 35 has at least two end positions of the connecting means 33, each corresponding to the first and second configurations for connecting the frame 3 to the body 2.

With reference to the body 2 of the saddle 1, the rear connecting zones 12, 14 of the body 2 each comprise at least one respective seat 36 for housing the removable connecting means 33 of the frame 3. Each seat 36 for housing the removable connecting means 33 of the frame 3 is inserted at least partly in the respective slot 35 of the first and second connecting elements 31, 32.

The housing seat 36 comprises a hollow tubular element in which a respective removable connecting means 33 engages.

In order to guarantee the tensioning of the body 2, each rear connecting zone 12, 14 of the frame 3 to the body 2 comprises a respective contact element 37 of the first connecting element 31 and of the second connecting element 32.

Each contact element 37 is in the form of a protrusion projecting outwards from the surface 2a of the body 2.

Each contact element 37 has a respective inclined face 37a designed to come into contact with a respective portion of the first connecting element 31 and the second connecting element 32.

The first connecting element 31 and the second connecting element 32 have respective inclined faces 31 a, 32a designed to make contact with the respective inclined face 37a of the respective contact element 37.

According to the invention, it is possible to adjust the width of the saddle 1 at least from a minimum width to a maximum width, and vice versa, in particular corresponding to the size defined on the market as a size“S”, or “small”, corresponding to the minimum width, and size “L”, or“large”, corresponding to the maximum width.

According to the invention, the bridge element 19 connecting the first branch 9 and the second branch 10 of the frame is configured to be removably coupled to the body 2 in such a way as to define a first and a second distance between the right rear portion 7 and the left rear portion 8 of the body 2.

In particular, the bridge element 19 has a face 19a configured to be coupled to at least part of the surface 2a of the body 2 facing towards the frame 3.

The bridge element 19 is configured to couple with the right rear portion 7 and with the left rear portion 8 of the body 2 in such a way as to position the right rear portion 7 and the left rear portion 8 according to a respective first connecting configuration and a second connecting configuration defining, respectively, the first distance and the second distance.

The first distance and at the second distance between the right rear portion 7 and the left rear portion 8 of the body 2, which can be obtained with the connecting of the bridge element 19 to the body 2, corresponds, respectively, to the first connecting configuration and the second connecting configuration of the frame 3 to the body 2.

In other words, the first distance between the right rear portion 7 and the left rear portion 8 corresponds to a minimum distance and the second distance between the right rear portion 7 and the left rear portion 8 corresponds to a maximum distance.

In particular, according to the invention, the bridge element 19 has, at the first face 19a designed for the connecting, a first seat 20 and a second seat 21 configured to receive a respective part of the right rear portion 7 of the body 2 and a first seat 22 and a second seat 23 configured to receive a respective part of the left rear portion 8 of the body 2.

The seats 20, 21, 22 and 23 for receiving the rear portion 5 of the body 2 define female elements in the connecting with the body 2.

In other words, the seats 20, 21, 22 and 23 for receiving the rear portion 5 of the body 2 are recesses.

With reference to the first seats 20, 22 and to the second seats 21, 23 of the bridge element 19 they are spaced from each other by a respective protrusion 46, 47, 48, 49 interposed between them.

The protrusions 46, 47, 48, 49 define male elements in the connecting between the body 2 and the bridge element 19.

The right rear portion 7 and the left rear portion 8 of the body 2 have a respective perimeter edge 7a, 8a of the surface 2a of the body 2 facing towards the frame 3, configured for connecting at least in part with the bridge element 19, in particular in respective first seats 20, 22 and second seats 21, 23.

The perimeter edges 7a, 8a of the right rear portion 7 and of the left rear portion 8 define male elements in the connecting with the bridge element 19.

Each edge 7a, 8a has a respective top surface 24, a lateral surface 25, facing towards the slot 6, and a lateral surface 26, facing towards the inside of the respective right and left rear portions 7, 8.

In other words, each edge 7a, 8a is shaped with a rectangular tooth profile.

In order to ensure a correct connecting between the bridge element 19 and the body 2, the body 2 has a first protrusion 27, positioned on the surface 2a of the right rear portion 7 of the body 2 facing towards the frame 3, and a second protrusion 28, positioned on the surface 2a of the left rear portion 8 of the body 2 facing towards the frame 3.

The first and second protrusions 27, 28 define male elements in the connecting with the bridge element 19.

The bridge element 19 has a third seat 29 configured to receive the first protrusion 27 of the right rear portion 7 and a third seat 30 configured to receive the second protrusion 28 of the left rear portion 8.

The third seat 29, 30 is spaced from the respective second seat 21, 23 by a respective protrusion 48, 49.

The protrusions 48, 49 define male elements in the connecting between the body 2 and the bridge element 19.

It should be noted that the first protrusion 27 and the second protrusion 28 are positioned parallel to the respective edge 7a, 8a at a distance such as to define a respective first seat 50 and second seat 51 each configured to receive a respective portion of the bridge element 19, in particular a respective protrusion 46, 47, 48, 49.

It should be noted that in this description the male elements of the bridge element 19 and of the body 2 involved in the connecting have the same shape, in particular rectangular. Consequently, the female elements of the bridge element 19 and of the body 2 involved in the connecting have the same shape.

In use, by inserting the perimeter edges 7a, 8a of the right rear portion 7 and of the left rear portion 8 in the respective first seat 20, 22, the first distance between the right rear portion 7 and the rear portion 8 is determined, that is to say, the minimum distance corresponding to the size “S”.

In this case, the first protrusion 27 and the second protrusion 28 of the body 2 are inserted in a respective second seat 21, 23 of the bridge element 19 and the first seat 50 and the second seat 51 of the body 2 receive a respective protrusion 46, 47 of the bridge element 19 positioned between the first seats 20, 22 and the second seats 21, 23 of the bridge element 19.

In order to change from the size“S” to the size“L”, the perimeter edges 7a, 8a of the right rear portion 7 and of the left rear portion 8 are inserted in the respective second seat 20, 22, determining the second distance between the right rear portion 7 and the rear portion 8, that is, the maximum distance between right rear portion 7 and left rear portion 8.

In this case, the first protrusion 27 and the second protrusion 28 of the body 2 are inserted in a respective third seat 29, 30 of the bridge element 19 and the first seat 50 and the second seat 51 of the body 2 receive a respective protrusion 48, 49 of the bridge element 19 positioned between the second seats 21, 23 and the third seats 29, 30 of the bridge element 19.

In general, the connecting between bridge element 19 and body 2 is determined by the connecting of male elements in respective female elements of the bridge element 19 and of the body 19.

According to the invention, the bridge element 19 is configured as an element which can be coupled to and uncoupled from the frame 3, in particular to the first branch 9 and the second branch 10.

The bridge element 19 comprises a first through hole and a second through hole 42 for passage, respectively, of the first branch 9 and second branch 10 of the frame 3.

According to the embodiment illustrated, the first connecting element 31 and the second connecting element 32 of the end portions 17, 18 of the branches 9, 10 of the frame 3 can be coupled to and uncoupled from the bridge element 19.

The bridge 19 element has a first seat 43 for housing at least part of the first connecting element 31 and a second seat 44 for housing at least part of the second connecting element 32, in particular for housing the portions of the first connecting element 31 and of the second connecting element 32 defining the seats 38, for receiving the end portions 17, 18 of the first branch 9 and of the second branch 10.

It should be noted that the first hole 41 for the passage of the first branch 9 leads into the first housing seat 43 of at least part of the first connecting element 31 in such a way as to allow the insertion of the end portion 17 of the first branch 9 in the first connecting element 31.

Similarly, the second hole 42 for the passage of the second branch 10 leads into the second housing seat 44 of at least part of the second connecting element 32 in such a way as to allow the insertion of the end portion 18 of the second branch 10 in the second connecting element 32.

It should be noted that in order to keep the body 2 under tension, the body 2 has, in the right rear portion 7 and in the left rear portion 8, a respective contact element 40 for a respective portion of the bridge element 19.

Each contact element 40 has a respective inclined face 40a designed to come into contact with a respective portion of the bridge element 19.

1. A saddle for bicycles, the saddle comprising a body and a frame supporting the body;
the body comprising at least one slot which extends at least partly in a rear portion forming a right rear portion and a left rear portion; the frame comprising at least a first branch and a second branch configured to be removably connected, respectively, to the right rear portion and to the left rear portion of the body passing at least from a first connecting configuration to a second connecting configuration, and vice versa;
a bridge element configured to connect the first branch and the second branch of the frame;
wherein the bridge element is configured for removably coupling to the body so as to define a first distance and a second distance between the right rear portion and the left rear portion of the body; the first distance and the second distance between the right rear portion and the left rear portion of the body corresponding, respectively, to the first connecting configuration and the second connecting configuration for connecting the frame to the body.

2. The saddle of claim 1, wherein the bridge element comprises a face configured for coupling with at least part of a surface of the body at the right rear portion and the left rear portion.

3. The saddle of claim 2, wherein the face of the bridge element and the surface of the body comprise respective male elements and female elements configured to be coupled.

4. The saddle of claim 1, wherein the bridge element comprises a first seat and a second seat each configured to receive a respective part of the right rear portion of the body and a first seat and a second seat each configured to receive a respective part of the left rear portion of the body.

5. The saddle of claim 1, wherein the right rear portion and the left rear portion of the body comprise a respective perimeter edge of the surface of the body facing towards the frame, configured for coupling at least in part with bridge element, in respective first seats and second seats of the bridge element.

6. The saddle of claim 1, wherein the body comprises a first protrusion, positioned on the surface of the right rear portion of the body facing towards the frame, and a second protrusion, positioned on the surface of the left rear portion of the body facing towards the frame.

7. The saddle of claim 6, wherein the first protrusion and the second protrusion are positioned parallel to the respective perimeter edge at a distance such as to define a respective first seat and second seat each configured to receive a respective protrusion of the bridge element positioned between the first seats and the second seats of the bridge element.

8. The saddle of claim 6, wherein the bridge element comprises a third seat configured to receive the first protrusion of the right rear portion and a third seat configured to receive the second protrusion of the left rear portion.

9. The saddle of claim 1, wherein the bridge element is an element coupable to and uncoupable from the first branch and the second branch of the frame, and wherein the bridge element comprises a first through hole and a second through hole for passage, respectively, of the first branch and of the second branch of the frame.

10. The saddle of claim 1, wherein the saddle comprises a first connecting element for coupling an end portion of the first branch to the body and a second connecting element for coupling an end portion of the second branch to the body; removable connecting means removably connect the first connecting element and the second connecting element to a respective rear connecting zone of the body, defining the first connecting configuration and the second connecting configuration, and vice versa.

11. The saddle of claim 10, wherein the bridge element comprises a first seat for housing at least part of the first connecting element and a second seat for housing at least part of the second connecting element; the first connecting element and the second connecting element being coupable and uncoupable relative to the bridge element.

12. The saddle of claim 1, wherein the right rear portion and the left rear portion of the body comprise a respective contact element of a respective portion of the bridge element.
